(19) United States
(12) Patent Application Publication
(10) Pub. No.: US 2024/0294021 A1
(43) Pub. Date: Sep. 5, 2024

(54) PRINTING APPARATUS AND METHOD OF CONTROLLING PRINTING APPARATUS

(71) Applicant: SEIKO EPSON CORPORATION, Tokyo (JP)

(72) Inventors: Ryo HAMANO, MATSUMOTO-SHI (JP); Yutaka HISHIDA, SHIOJIRI-SHI (JP)

(21) Appl. No.: 18/592,027

(22) Filed: Feb. 29, 2024

(30) Foreign Application Priority Data
Mar. 2, 2023 (JP) 2023-031665

(51) Int. Cl. B41J 15/16; B41J 15/02; B41J 15/04; B65H 23/04

(52) U.S. Cl. CPC B41J 15/165; B41J 15/02; B41J 15/04; B65H 23/048; B65H 2553/51

(57) ABSTRACT

A printing apparatus includes: a feeding shaft configured to support a roll body; a printing section configured to perform printing on a medium fed from the feeding shaft; a tension applying unit configured to come into contact with the medium after the medium is fed out from the feeding shaft and before the medium reaches the printing section, thereby applying tension to the medium; and a control unit, in which the tension applying unit includes: a tension bar configured to come into contact with the medium; an arm configured to support the tension bar and rotate to displace the tension bar; an encoder configured to detect a rotational angle of the arm; and a stopper configured to come into contact with the tension bar or the arm to restrict movement of the tension bar and the arm, and the control unit sets, as a reference angle of the arm, a rotational angle of the arm detected by the encoder in a state in which the tension bar or the arm is in contact with the stopper.

The present application is based on, and claims priority from JP Application Serial Number 2023-031665, filed on Mar. 2, 2023, the disclosure of which is hereby incorporated by reference herein in its entirety.

### BACKGROUND

### 1. Technical Field

The present disclosure relates to a printing apparatus and a method of controlling a printing apparatus.

### 2. Related Art

JP-A-2012-254887 describes a printing apparatus including a tension bar and an arm. A medium fed from a roll body is looped over the tension bar, and the tension bar is configured to apply tension to the medium. The arm is configured to support the tension bar. The arm rotates, thereby displacing the tension bar. The printing apparatus uses an encoder to detect the position of the tension bar. The printing apparatus adjusts the feeding velocity of the medium on the basis of the position of the tension bar.

The printing apparatus described in JP-A-2012-254887 includes a photosensor in order to set the reference angle of the arm. Wiring is required for the photosensor. Thus, in this case, there is a possibility that the configuration of the printing apparatus is complicated due to the photosensor.

### SUMMARY

A printing apparatus configured to solve the problem described above includes a feeding shaft configured to support a roll body around which a medium is wound, a printing section configured to perform printing on the medium fed by the feeding shaft, a tension applying unit configured to come into contact with the medium after the medium is fed out from the feeding shaft and before the medium reaches the printing section, thereby applying tension to the medium, and a control unit, in which the tension applying unit includes a tension bar configured to come into contact with the medium, an arm configured to support the tension bar and rotate to displace the tension bar, an encoder configured to detect a rotational angle of the arm, and a stopper configured to come into contact with the tension bar or the arm to restrict movement of the tension bar and the arm, and the control unit sets, as a reference angle of the arm, a rotational angle of the arm detected by the encoder in a state in which the tension bar or the arm is in contact with the stopper.

A method of controlling a printing apparatus configured to solve the problem described above provides a method of controlling a printing apparatus including a feeding shaft configured to support a roll body around which a medium is wound, a printing section configured to perform printing on the medium fed by the feeding shaft, and a tension applying unit configured to come into contact with the medium after the medium is fed out from the feeding shaft and before the medium reaches the printing section, thereby applying tension to the medium, in which the tension applying unit includes a tension bar configured to come into contact with the medium, an arm configured to support the tension bar and rotate to displace the tension bar, an encoder configured to detect a rotational angle of the arm, and a stopper configured to come into contact with the tension bar or the arm to restrict movement of the tension bar and the arm, the method including causing the tension bar or the arm to come into contact with the stopper, and setting, as a reference angle of the arm, a rotational angle of the arm detected by the encoder in a state in which the tension bar or the arm is in contact with the stopper.

### BRIEF DESCRIPTION OF THE DRAWINGS

FIG. 1 is a side view illustrating an embodiment of a printing apparatus.

FIG. 2 is a side view illustrating a feeding unit.

FIG. 3 is a side view illustrating a winding unit.

FIG. 4 is a flowchart illustrating one example of a setting operation.

### DESCRIPTION OF EMBODIMENTS

Below, an embodiment of the printing apparatus will be described with reference to the drawings. The printing apparatus is, for example, an ink jet-type printer configured to discharge ink serving as one example of a liquid to a medium such as a sheet or fabric to print an image of a character, a photo, or the like.

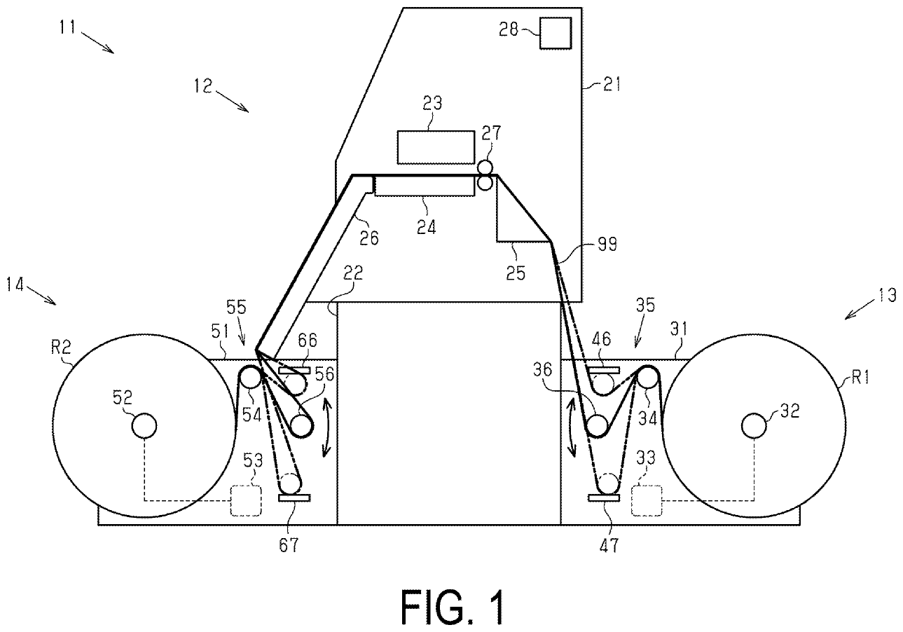

As illustrated in FIG. 1, a printing apparatus 11 includes a printing unit 12, a feeding unit 13, and a winding unit 14. The printing unit 12, the feeding unit 13, and the winding unit 14 may cooperate with each other or may not cooperate with each other. That is, the printing unit 12, the feeding unit 13, and the winding unit 14 may communicate with each other or may not communicate with each other.

### Printing Unit

First, the printing unit 12 will be described. The printing unit 12 is a unit configured to perform printing on a medium 99. The printing unit 12 performs printing on the medium 99 fed out from the feeding unit 13. The medium 99 is wound by the winding unit 14 after printing is performed by the printing unit 12. The printing unit 12 performs printing on the medium 99 after the medium 99 is fed out by the feeding unit 13 and before the medium is wound by the winding unit 14. The printing unit 12 performs printing on a long-length medium 99 extending from the feeding unit 13 over the winding unit 14.

The printing unit 12 includes a housing 21. The printing unit 12 includes a leg section 22. The leg section 22 supports the housing 21.

The printing unit 12 includes a printing section 23. The printing section 23 is disposed within the housing 21. The printing section 23 is configured to perform printing on the medium 99. As one example, the printing section 23 is a head configured to discharge a liquid on the medium 99. The printing section 23 may be a serial head configured to scan with respect to the medium 99, or may be a line head configured to be able to discharge a liquid throughout the width of the medium 99 at the same time. The printing section 23 may perform printing on the medium 99 through toner jet, or may perform printing on the medium 99 through dot impact.

The printing unit 12 includes a support portion 24. The support portion 24 is disposed within the housing 21. The support portion 24 supports the medium 99. The support portion 24 is opposed to the printing section 23. The support portion 24 supports a region of the medium 99 on which printing is performed by the printing section 23.

The printing unit 12 may include an upstream support portion 25. The upstream support portion 25 may be disposed within the housing 21 or may be disposed outside of the housing 21. The upstream support portion 25 is disposed upstream of the support portion 24 in a transport direction of the medium 99. The upstream support portion 25 supports a region of the medium 99 that is disposed upstream of the region that the support portion 24 supports. By supporting the medium 99, the upstream support portion 25 guides the medium 99 from the feeding unit 13 to the support portion 24.

The printing unit 12 may include a downstream support portion 26. The downstream support portion 26 may be disposed within the housing 21 or may be disposed outside of the housing 21. The downstream support portion 26 is disposed downstream of the support portion 24 in the transport direction. The downstream support portion 26 supports a region of the medium 99 that is disposed downstream of the region that the support portion 24 supports. By supporting the medium 99, the downstream support portion 26 guides the medium 99 from the support portion 24 to the winding unit 14.

The printing unit 12 includes a transport unit 27. The transport unit 27 is configured to transport the medium 99. The transport unit 27 is disposed within the housing 21. The transport unit 27 transports the medium 99 to the printing section 23. The transport unit 27 transports the medium 99 fed out from the feeding unit 13. The transport unit 27 transports the medium 99 from the feeding unit 13 toward the winding unit 14. In one example, the transport unit 27 is disposed between the support portion 24 and the upstream support portion 25. The transport unit 27 includes, for example, a roller pair. In this case, by rotating in a state of interposing the medium 99, the transport unit 27 transports the medium 99.

The printing unit 12 includes a control unit. Specifically, the printing unit 12 includes a printing control unit 28. The printing control unit 28 controls the printing unit 12. The printing control unit 28 controls, for example, the printing section 23 and the transport unit 27.

The printing control unit 28 may be configured with one or more processors configured to perform various types of processes in accordance with a computer program. The printing control unit 28 may be configured with one or more dedicated hardware circuits such as an application specific integrated circuit that performs at least a portion of processes from among various types of processes. The printing control unit 28 may be configured with a circuit including a combination of a processor and a hardware circuit. The processor includes a CPU and a memory such as a RAM and a ROM. The memory holds a program code configured so as to cause the CPU to perform a process, or an instruction. The memory, that is, a computer readable medium includes any type of readable medium that a general-type or dedicated computer can access.

### Feeding Unit

Next, the feeding unit 13 will be described. The feeding unit 13 is a unit configured to feed out the medium 99 to the printing unit 12. The feeding unit 13 feeds out the medium 99 from a roll body around which the medium 99 is wound, to the printing unit 12. Specifically, the feeding unit 13 feeds out the medium 99 from a first roll body R1 around which the medium 99 before printing is wound, to the printing unit 12.

The feeding unit 13 is attached to the printing unit 12. In one example, the feeding unit 13 is attached to the leg section 22. The feeding unit 13 is disposed lower than the support portion 24. Thus, the feeding unit 13 feeds out the medium 99 upward toward the printing unit 12.

The feeding unit 13 includes a frame. Specifically, the feeding unit 13 includes a first frame 31. The first frame 31 is attached, for example, to the leg section 22. The first frame 31 holds various types of components that the feeding unit 13 includes.

The feeding unit 13 includes a feeding shaft 32. The feeding shaft 32 is a shaft configured to support the first roll body R1. As the feeding shaft 32 rotates, the medium 99 is fed out from the first roll body R1. The feeding shaft 32 is attached to the first frame 31.

The feeding unit 13 includes a driving unit. Specifically, the feeding unit 13 includes a first driving unit 33. The first driving unit 33 is configured so as to rotate the feeding shaft 32. The first driving unit 33 includes, for example, a motor. The first driving unit 33 is coupled to the feeding shaft 32. As the first driving unit 33 causes the feeding shaft 32 to rotate, the medium 99 is fed out from the first roll body R1.

The feeding unit 13 includes a guide roller. Specifically, the feeding unit 13 includes a first guide roller 34. The first guide roller 34 is attached to the first frame 31. The medium 99 fed out from the first roll body R1 is looped over the first guide roller 34. In one example, the medium 99 is looped over the first guide roller 34 from above. The first guide roller 34 guides the medium 99 fed out from the first roll body R1. Specifically, the first guide roller 34 guides the medium 99 to a tension applying unit that will be described later.

The feeding unit 13 includes the tension applying unit. Specifically, the feeding unit 13 includes a first tension applying unit 35. The first tension applying unit 35 is configured so as to apply tension to the medium 99. The first tension applying unit 35 comes into contact with the medium 99 after the medium 99 is fed out from the feeding shaft 32 and before the medium reaches the printing section 23, thereby applying tension to the medium 99. Specifically, the first tension applying unit 35 comes into contact with the medium 99 at a portion of the medium 99 between the feeding shaft 32 and the transport unit 27, thereby applying tension to the medium 99. With the first tension applying unit 35 applying appropriate tension to the medium 99, the medium 99 is smoothly fed out from the feeding unit 13 toward the printing unit 12.

The first tension applying unit 35 includes a tension bar. Specifically, the first tension applying unit 35 includes a first tension bar 36. The first tension bar 36 comes into contact with the medium 99. The medium 99 is looped over the first tension bar 36. Specifically, the medium 99 guided by the first guide roller 34 is looped over the first tension bar 36. The first tension bar 36 is disposed such that the medium 99 is looped over from below. Thus, by pressing downward the medium 99, the first tension bar 36 applies tension to the medium 99. The first tension bar 36 applies a certain amount of tension to the medium 99 under its own weight.

The first tension bar 36 is configured to be displaced upward and downward. The first tension bar 36 is displaced while applying a certain amount of tension to the medium 99. The first tension bar 36 is displaced in accordance with a difference between a velocity of transport of the medium 99 by the transport unit 27 and a velocity of feeding of the medium 99 by the feeding shaft 32. That is, when the transport velocity is faster than the feeding velocity, the medium 99 is pulled by the transport unit 27. In this case, as the transport unit 27 pulls the medium 99, the first tension bar 36 moves upward. When the transport velocity is slower than the feeding velocity, the medium 99 is loosened. In this case, as the medium 99 is loosened, the first tension bar 36 moves downward.

The feeding unit 13 controls the feeding velocity by the feeding shaft 32 such that the first tension bar 36 is disposed at a predetermined position. Specifically, the feeding unit 13 controls the feeding velocity by the feeding shaft 32 such that the position of the first tension bar 36 falls in a predetermined region. By positioning the first tension bar 36 at the predetermined position, it is possible to apply appropriate tension to the medium 99. For example, when the first tension bar 36 is disposed higher than the predetermined position, the feeding unit 13 increases the feeding velocity. When the first tension bar 36 is disposed lower than the predetermined position, the feeding unit 13 reduces the feeding velocity. This makes it possible to keep the first tension bar 36 in a state of being disposed at the predetermined position.

The first tension bar 36 is a roller. Thus, the first tension bar 36 rotates in association with feeding out of the medium 99. This reduces friction between the first tension bar 36 and the medium 99, which makes it possible to smoothly transport the medium 99. The first tension bar 36 may be configured, for example, with a rod that is unable to rotate.

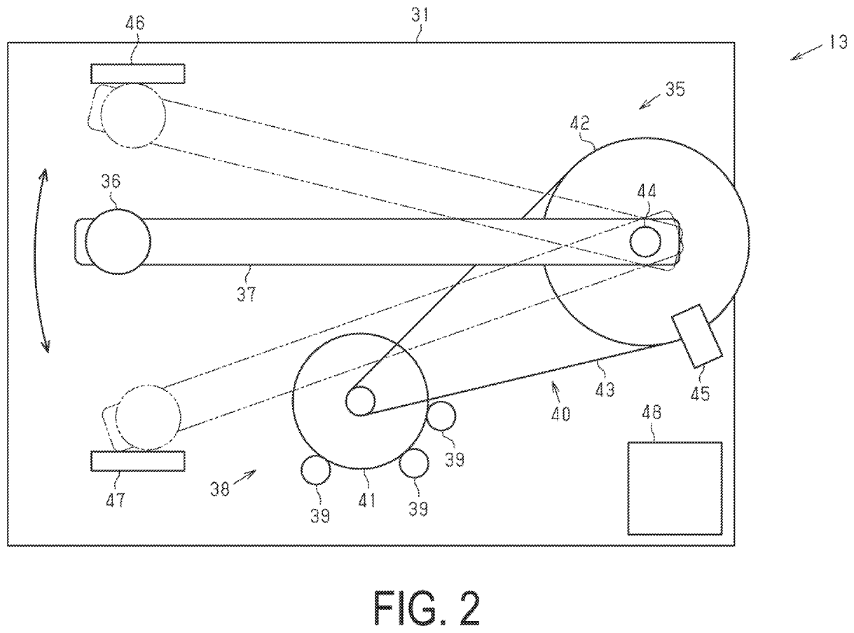

As illustrated in FIG. 2, the first tension applying unit 35 includes an arm. Specifically, the first tension applying unit 35 includes a first arm 37. The first arm 37 supports the first tension bar 36. Specifically, the first tension bar 36 is attached at a tip portion of the first arm 37.

The first arm 37 is configured so as to rotate. Specifically, the first arm 37 rotates with its base end portion being the axis. By rotating, the first arm 37 causes the first tension bar 36 to be displaced. That is, with the first arm 37 rotating, the first tension bar 36 moves upward and downward.

The first tension applying unit 35 includes a rotary mechanism. Specifically, the first tension applying unit 35 includes a first rotary mechanism 38. The first rotary mechanism 38 is a mechanism configured to cause the first arm 37 to rotate.

The first rotary mechanism 38 includes a motor. Specifically, the first rotary mechanism 38 includes a first motor 39. The first rotary mechanism 38 may include a plurality of first motors 39. The first motor 39 is configured to cause the first arm 37 to rotate. The first motor 39 causes the first tension bar 36 to be displaced. The first motor 39 may constitute the first driving unit 33.

The first rotary mechanism 38 includes a transmission mechanism. Specifically, the first rotary mechanism 38 includes a first transmission mechanism 40. The first transmission mechanism 40 is a mechanism configured to transmit power of the first motor 39 to the first arm 37.

The first transmission mechanism 40 includes a driving gear, a driven gear, and a transmission belt. Specifically, the first transmission mechanism 40 includes a first driving gear 41, a first driven gear 42, and a first transmission belt 43. The first transmission belt 43 is looped over the first driving gear 41 and the first driven gear 42.

The first driving gear 41 is coupled to the first motor 39. The first driving gear 41 is rotated by the first motor 39.

The first driven gear 42 is coupled to the first driving gear 41 through the first transmission belt 43. This enables the first driven gear 42 to follow the first driving gear 41 and drive. As the first driving gear 41 rotates, the first driven gear 42 rotates.

The first driven gear 42 includes a rotary shaft. Specifically, the first driven gear 42 includes a first rotary shaft 44. The first driven gear 42 rotates with the first rotary shaft 44 being the center. The first arm 37 is attached to the first rotary shaft 44. The first rotary shaft 44 is attached at a base end portion of the first arm 37. As the first rotary shaft 44 rotates, the first arm 37 rotates. Thus, the first driven gear 42 operates in conjunction with the first arm 37. The first rotary shaft 44 may be disposed so as to be coaxial with the feeding shaft 32.

The first tension applying unit 35 includes an encoder. Specifically, the first tension applying unit 35 includes a first encoder 45. The first encoder 45 detects a rotational angle of the first arm 37. The first encoder 45 is, for example, a rotary encoder. In one example, the first encoder 45 detects a rotational angle of the first driven gear 42. The first encoder 45 converts the rotational angle of the first driven gear 42 into the rotational angle of the first arm 37. In this manner, the first encoder 45 detects the rotational angle of the first arm 37. The first encoder 45 detects the rotational angle of the first arm 37, which makes it possible to grasp the position of the first tension bar 36. The first encoder 45 may detect the rotational angle of the first driving gear 41. In the feeding unit 13, the position of the first tension bar 36 is controlled on the basis of the rotational angle of the first arm 37 that the first encoder 45 detects.

When the first encoder 45 detects the rotational angle of the first arm 37, it is necessary to set a reference angle of the first arm 37 that serves as a reference in measurement by the first encoder 45. By counting an encoder pulse from the reference angle, the first encoder 45 detects the rotational angle of the first arm 37. Thus, the first tension applying unit 35 includes a stopper used to set the reference angle of the first arm 37.

The first tension applying unit 35 includes one or more stoppers. The stopper comes into contact with the first tension bar 36 or the first arm 37, thereby restricting movement of the first tension bar 36 and the first arm 37. The first tension applying unit 35 includes, for example, an upper-side stopper and a lower-side stopper. Specifically, the first tension applying unit 35 includes a first upper-side stopper 46 and a first lower-side stopper 47. The first upper-side stopper 46 and the first lower-side stopper 47 are disposed so as to interpose the first tension bar 36 from above and below. The region between the first upper-side stopper 46 and the first lower-side stopper 47 is a region where the first tension bar 36 moves.

The first upper-side stopper 46 comes into contact with the first tension bar 36 or the first arm 37. In one example, the first upper-side stopper 46 comes into contact with the first tension bar 36. Specifically, the first upper-side stopper 46 comes into contact with the first tension bar 36 from above. With this configuration, the first upper-side stopper 46 restricts upward movement of the first tension bar 36 and the first arm 37. The feeding unit 13 is able to set the reference angle to be a rotational angle of the first arm 37 in a state in which the first tension bar 36 is in contact with the first upper-side stopper 46.

The first lower-side stopper 47 comes into contact with the first tension bar 36 or the first arm 37. In one example, the first lower-side stopper 47 comes into contact with the first tension bar 36. Specifically, the first lower-side stopper 47 comes into contact with the first tension bar 36 from below. With this configuration, the first lower-side stopper 47 restricts downward movement of the first tension bar 36 and the first arm 37. The feeding unit 13 is able to set the reference angle to be a rotational angle of the first arm 37 in a state in which the first tension bar 36 is in contact with the first lower-side stopper 47.

The feeding unit 13 includes a control unit. Specifically, the feeding unit 13 includes a feeding control unit 48. The feeding control unit 48 controls the feeding unit 13. The feeding control unit 48 controls, for example, the feeding shaft 32, the first tension applying unit 35, and the like. The feeding control unit 48 may be configured with a processor, as with the printing control unit 28, or may be configured with a hardware circuit, or may be configured with a circuit including a combination of the processor and the hardware circuit.

The feeding control unit 48 controls rotation of the feeding shaft 32 on the basis of the rotational angle of the first arm 37 detected by the first encoder 45. The feeding control unit 48 controls rotation of the feeding shaft 32 such that the first tension bar 36 is disposed at a predetermined position. By controlling the first motor 39, the feeding control unit 48 controls the velocity of feeding by the feeding shaft 32.

The feeding control unit 48 may be configured so as to be able to communicate with the printing control unit 28 or may not communicate with the printing control unit 28. The feeding control unit 48 controls the velocity of feeding by the feeding shaft 32 on the basis of the position of the first tension bar 36. This makes it possible to appropriately feed out the medium 99 even if any parameter indicating the velocity of transport by the transport unit 27 is not obtained from the printing apparatus 11.

The feeding control unit 48 sets, as the reference angle, the rotational angle of the first arm 37 detected by the first encoder 45 in a state in which the first tension bar 36 is in contact with the first upper-side stopper 46 or the first lower-side stopper 47. Specifically, the feeding control unit 48 controls the first motor 39 to bring the first tension bar 36 into contact with the first upper-side stopper 46 or the first lower-side stopper 47. At this time, the feeding control unit 48 detects that the first tension bar 36 or the first arm 37 is in contact with the stopper on the basis of a torque of the first motor 39 such as a load current of the first motor 39. When a load current corresponding to the toque of the first motor 39 equal to or more than a predetermined torque flows through the first motor 39, the feeding control unit 48 grasps that the first tension bar 36 or the first arm 37 is in contact with the stopper. Thus, the feeding control unit 48 sets, as the reference angle, a rotational angle of the first arm 37 detected by the first encoder 45 in a state in which a load current corresponding to the toque of the first motor 39 equal to or more than a predetermined torque flows through the first motor 39.

At the time of setting the reference angle, it is preferable to make the first tension bar 36 or the first arm 37 come into contact with the first upper-side stopper 46, rather than with the first lower-side stopper 47. This is because the medium 99 is looped over the first tension bar 36 from below and hence, the first tension bar 36 receives, from the medium 99, force that causes it to be lifted upward. That is, because force acts on the first tension bar 36 such that the first tension bar 36 or the first arm 37 moves away from the first lower-side stopper 47, torque of the first motor 39 is less likely to be stable.

### Winding Unit 14

Next, the winding unit 14 will be described. In one example, the winding unit 14 has a configuration similar to that of the feeding unit 13. The winding unit 14 is a unit configured to wind the medium 99 from the printing unit 12. The winding unit 14 winds the medium 99 from the printing unit 12, thereby holding the roll body. Specifically, the winding unit 14 holds a second roll body R2 around which the medium 99 on which printing has been performed is wound.

As illustrated in FIG. 1, the winding unit 14 is attached to the printing unit 12. In one example, the winding unit 14 is attached at the leg section 22. The winding unit 14 is disposed lower than the support portion 24. Thus, the winding unit 14 winds downward the medium 99 from the printing unit 12.

The winding unit 14 includes a frame. Specifically, the winding unit 14 includes a second frame 51. The second frame 51 is attached, for example, at the leg section 22. The second frame 51 holds various configurations that the winding unit 14 includes.

The winding unit 14 includes a winding shaft 52. The winding shaft 52 is a shaft configured to support the second roll body R2. As the winding shaft 52 rotates, the medium 99 is wound around the winding shaft 52. The winding shaft 52 is attached at the second frame 51.

The winding unit 14 includes a driving unit. Specifically, the winding unit 14 includes a second driving unit 53. The second driving unit 53 is configured so as to rotate the winding shaft 52. The second driving unit 53 includes, for example, a motor. The second driving unit 53 is coupled to the winding shaft 52. As the second driving unit 53 causes the winding shaft 52 to rotate, the medium 99 is wound around the winding shaft 52.

The winding unit 14 includes a guide roller.

Specifically, the winding unit 14 includes a second guide roller 54. The second guide roller 54 is attached at the second frame 51. The medium 99 to be wound around the winding shaft 52 is looped over the second guide roller 54. In one example, the medium 99 is looped over the second guide roller 54 from above. The second guide roller 54 guides the medium 99 to be wound around the winding shaft 52. Specifically, the second guide roller 54 guides the medium 99 from a tension applying unit, which will be described later, to the winding shaft 52.

The winding unit 14 includes a tension applying unit. Specifically, the winding unit 14 includes a second tension applying unit 55. The second tension applying unit 55 is configured to apply tension to the medium 99. The second tension applying unit 55 comes into contact with the medium 99 after the printing section 23 performs printing on the medium 99 and before the medium is wound around the winding shaft 52, thereby applying tension to the medium 99. Specifically, the second tension applying unit 55 comes into contact with the medium 99 at a portion of the medium 99 between the transport unit 27 and the winding shaft 52, thereby applying tension to the medium 99. With the second tension applying unit 55 applying appropriate tension to the medium 99, the medium 99 is smoothly wound by the winding unit 14 from the printing unit 12.

The second tension applying unit 55 includes a tension bar. Specifically, the second tension applying unit 55 includes a second tension bar 56. The second tension bar 56 comes into contact with the medium 99. The medium 99 is looped over the second tension bar 56. Specifically, the medium 99 guided by the downstream support portion 26 is looped over the second tension bar 56. The second tension bar 56 is disposed such that the medium 99 is looped over from below. Thus, by pressing downward the medium 99, the second tension bar 56 applies tension to the medium 99. The second tension bar 56 applies a certain amount of tension to the medium 99 under its own weight.

The second tension bar 56 is configured to be displaced upward and downward. The second tension bar 56 is displaced while applying a certain amount of tension to the medium 99. The second tension bar 56 is displaced in accordance with a difference between a velocity of transport of the medium 99 by the transport unit 27 and a velocity of winding of the medium 99 by the winding shaft 52. That is, when the transport velocity is faster than the winding speed, the medium 99 is loosened due to the transport unit 27. In this case, the second tension bar 56 moves downward due to the medium 99 being loosened. When the transport velocity is slower than the winding speed, the medium 99 is pulled by the winding shaft 52. In this case, at the second tension bar 56, as the winding shaft 52 pulls the medium 99, the second tension bar 56 moves upward.

The winding unit 14 controls the winding speed by the winding shaft 52 such that the second tension bar 56 is disposed at a predetermined position. Specifically, the winding unit 14 controls the winding speed by the winding shaft 52 such that the position of the second tension bar 56 falls in a predetermined region. By positioning the second tension bar 56 at the predetermined position, it is possible to apply appropriate tension to the medium 99. For example, when the second tension bar 56 is disposed higher than the predetermined position, the winding unit 14 reduces the winding speed. When the second tension bar 56 is disposed lower than the predetermined position, the winding unit 14 increases the winding speed. This makes it possible to keep the second tension bar 56 in a state of being disposed at the predetermined position.

The second tension bar 56 is a roller. Thus, the second tension bar 56 rotates in association with winding of the medium 99. This reduces friction between the second tension bar 56 and the medium 99, which makes it possible to smoothly transport the medium 99. The second tension bar 56 may be configured, for example, with a rod that is unable to rotate.

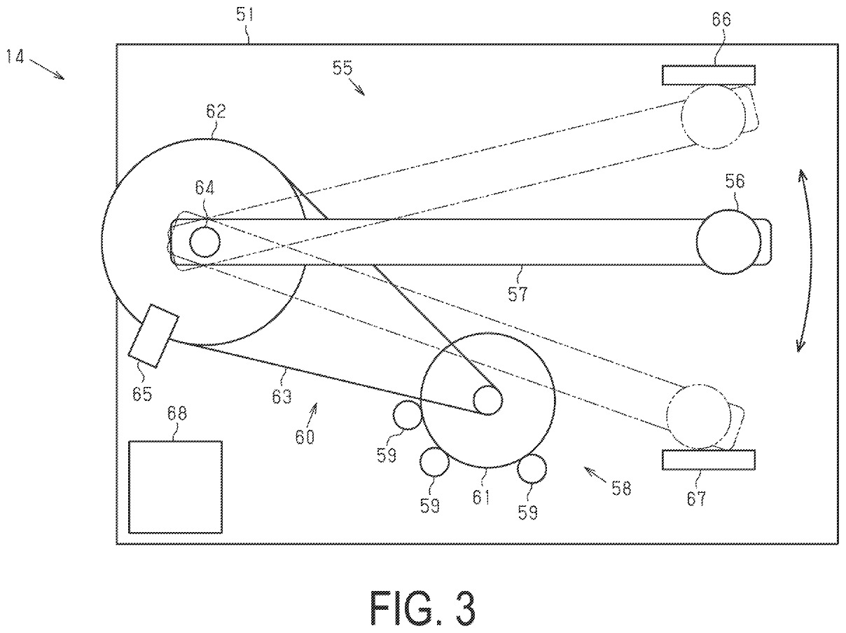

As illustrated in FIG. 3, the second tension applying unit 55 includes an arm. Specifically, the second tension applying unit 55 includes a second arm 57. The second arm 57 supports the second tension bar 56. Specifically, the second tension bar 56 is attached at a tip portion of the second arm 57.

The second arm 57 is configured so as to rotate. Specifically, the second arm 57 rotates with its base end portion being the axis. By rotating, the second arm 57 causes the second tension bar 56 to be displaced. That is, with the second arm 57 rotating, the second tension bar 56 moves upward and downward.

The second tension applying unit 55 includes a rotary mechanism. Specifically, the second tension applying unit 55 includes a second rotary mechanism 58. The second rotary mechanism 58 is a mechanism configured to cause the second arm 57 to rotate.

The second rotary mechanism 58 includes a motor. Specifically, the second rotary mechanism 58 includes a second motor 59. The second rotary mechanism 58 may include a plurality of second motors 59. The second motor 59 is configured to cause the second arm 57 to rotate. The second motor 59 causes the second tension bar 56 to be displaced. The second motor 59 may constitute the second driving unit 53.

The second rotary mechanism 58 includes a transmission mechanism. Specifically, the second rotary mechanism 58 includes a second transmission mechanism 60. The second transmission mechanism 60 is a mechanism configured to transmit power of the second motor 59 to the second arm 57.

The second transmission mechanism 60 includes a driving gear, a driven gear, and a transmission belt. Specifically, the second transmission mechanism 60 includes a second driving gear 61, a second driven gear 62, and a second transmission belt 63. The second transmission belt 63 is looped over the second driving gear 61 and the second driven gear 62.

The second driving gear 61 is coupled to the second motor 59. The second driving gear 61 is rotated by the second motor 59.

The second driven gear 62 is coupled to the second driving gear 61 through the second transmission belt 63. This enables the second driven gear 62 to follow the second driving gear 61 and drive. As the second driving gear 61 rotates, the second driven gear 62 rotates.

The second driven gear 62 includes a rotary shaft. Specifically, the second driven gear 62 includes a second rotary shaft 64. The second driven gear 62 rotates with the second rotary shaft 64 being the center. The second arm 57 is attached to the second rotary shaft 64. The second rotary shaft 64 is attached at a base end portion of the second arm 57. As the second rotary shaft 64 rotates, the second arm 57 rotates. Thus, the second driven gear 62 operates in conjunction with the second arm 57. The second rotary shaft 64 may be disposed so as to be coaxial with the winding shaft 52.

The second tension applying unit 55 includes an encoder. Specifically, the second tension applying unit 55 includes a second encoder 65. The second encoder 65 detects a rotational angle of the second arm 57. The second encoder 65 is, for example, a rotary encoder. In one example, the second encoder 65 detects a rotational angle of the second driven gear 62. The second encoder 65 converts the rotational angle of the second driven gear 62 into the rotational angle of the second arm 57. In this manner, the second encoder 65 detects the rotational angle of the second arm 57. The second encoder 65 detects the rotational angle of the second arm 57, which makes it possible to grasp the position of the second tension bar 56. The second encoder 65 may detect the rotational angle of the second driving gear 61. In the winding unit 14, the position of the second tension bar 56 is controlled on the basis of the rotational angle of the second arm 57 that the second encoder 65 detects.

When the second encoder 65 detects the rotational angle of the second arm 57, it is necessary to set a reference angle of the second arm 57 that serves as a reference in measurement by the second encoder 65, as with the first encoder 45. By counting an encoder pulse from the reference angle, the second encoder 65 detects the rotational angle of the second arm 57. Thus, the second tension applying unit 55 includes a stopper used to set the reference angle of the second arm 57.

The second tension applying unit 55 includes one or more stoppers. The stopper comes into contact with the second tension bar 56 or the second arm 57, thereby restricting movement of the second tension bar 56 and the second arm 57. The second tension applying unit 55 includes, for example, an upper-side stopper and a lower-side stopper. Specifically, the second tension applying unit 55 includes a second upper-side stopper 66 and a second lower-side stopper 67. The second upper-side stopper 66 and the second lower-side stopper 67 are disposed so as to interpose the second tension bar 56 from above and below. The region between the second upper-side stopper 66 and the second lower-side stopper 67 is a region where the second tension bar 56 moves.

The second upper-side stopper 66 comes into contact with the second tension bar 56 or the second arm 57. In one example, the second upper-side stopper 66 comes into contact with the second tension bar 56. Specifically, the second upper-side stopper 66 comes into contact with the second tension bar 56 from above. With this configuration, the second upper-side stopper 66 restricts upward movement of the second tension bar 56 and the second arm 57. The winding unit 14 is able to set, as the reference angle, a rotational angle of the second arm 57 in a state in which the second tension bar 56 is in contact with the second upper-side stopper 66.

The second lower-side stopper 67 comes into contact with the second tension bar 56 or the second arm 57. In one example, the second lower-side stopper 67 comes into contact with the second tension bar 56. Specifically, the second lower-side stopper 67 comes into contact with the second tension bar 56 from below. With this configuration, the second lower-side stopper 67 restricts downward movement of the second tension bar 56 and the second arm 57. The winding unit 14 is able to set, as the reference angle, a rotational angle of the second arm 57 in a state in which the second tension bar 56 is in contact with the second lower-side stopper 67.

The winding unit 14 includes a control unit. Specifically, the winding unit 14 includes a winding control unit 68. The winding control unit 68 controls the winding unit 14. The winding control unit 68 controls, for example, the winding shaft 52, the second tension applying unit 55, and the like. The winding control unit 68 may be configured with a processor, as with the printing control unit 28, or may be configured with a hardware circuit, or may be configured with a circuit including a combination of the processor and the hardware circuit.

The winding control unit 68 controls rotation of the winding shaft 52 on the basis of the rotational angle of the second arm 57 detected by the second encoder 65. The winding control unit 68 controls rotation of the winding shaft 52 such that the second tension bar 56 is disposed at a predetermined position. By controlling the second motor 59, the winding control unit 68 controls the velocity of feeding by the winding shaft 52.

The winding control unit 68 may be configured so as to be able to communicate with the printing control unit 28 or may not communicate with the printing control unit 28. The winding control unit 68 controls the velocity of winding by the winding shaft 52 on the basis of the position of the second tension bar 56. This makes it possible to appropriately wind the medium 99 even if any parameter indicating the velocity of transport by the transport unit 27 is not obtained from the printing apparatus 11. The winding control unit 68 may be configured so as to be able to communicate with the feeding control unit 48 or may not communicate with the feeding control unit 48.

The winding control unit 68 sets, as the reference angle, a rotational angle of the second arm 57 detected by the second encoder 65 in a state in which the second tension bar 56 is in contact with the second upper-side stopper 66 or the second lower-side stopper 67. Specifically, the winding control unit 68 controls the second motor 59 to bring the second tension bar 56 into contact with the second upper-side stopper 66 or the second lower-side stopper 67. At this time, the winding control unit 68 detects that the second tension bar 56 or the second arm 57 is in contact with the stopper on the basis of a torque of the second motor 59 such as a load current of the second motor 59. When a load current corresponding to the toque of the second motor 59 equal to or more than a predetermined torque flows through the second motor 59, the winding control unit 68 grasps that the second tension bar 56 or the second arm 57 is in contact with the stopper. Thus, the winding control unit 68 sets, as the reference angle, a rotational angle of the second arm 57 detected by the second encoder 65 in a state in which a load current corresponding to the toque of the second motor 59 equal to or more than a predetermined torque flows through the second motor 59.

At the time of setting the reference angle, it is preferable to make the second tension bar 56 or the second arm 57 come into contact with the second upper-side stopper 66, rather than with the second lower-side stopper 67. This is because the medium 99 is looped over the second tension bar 56 from below and hence, the second tension bar 56 receives, from the medium 99, force that causes it to be lifted upward. That is, because force acts on the second tension bar 56 such that the second tension bar 56 or the second arm 57 moves away from the second lower-side stopper 67, torque of the second motor 59 is less likely to be stable.

### Setting Operation

Next, a setting operation of the printing apparatus 11 will be described. The setting operation is an operation of setting a reference angle of the encoder. Thus, the setting operation is performed in each of the feeding unit 13 and the winding unit 14. The setting operation may be performed by the printing control unit 28, or may be performed by the feeding control unit 48, or may be performed by the winding control unit 68. The setting operation is performed, for example, at the time of turning on the power of the printing apparatus 11. The setting operation may be performed at the time of activating the feeding unit 13 or may be performed at the time of activating the winding unit 14.

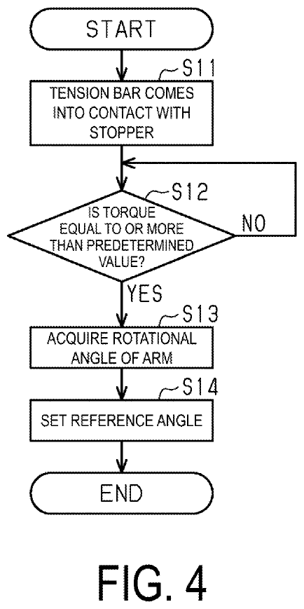

In step S11, the control unit causes the tension bar to come into contact with the stopper as illustrated in FIG. 4. At this time, the control unit controls the motor to cause the tension bar to come into contact with the stopper. The control unit may cause the arm to come into contact with the stopper.

In step S12, the control unit determines whether or not the torque of the motor is equal to or more than a predetermined value. For example, the control unit determines whether or not the load current flowing though the motor is equal to or more than a predetermined current. When the torque of the motor is equal to or more than the predetermined value, the control unit determines that the tension bar comes into contact with the stopper. In this case, the control unit moves the process to step S13. When the torque of the motor is less than the predetermined value, the control unit repeats the process of step S12. Thus, the control unit repeats the process of step S12 until the torque of the motor is equal to or more than the predetermined value.

In step S13, the control unit acquires the rotational angle of the arm from the encoder. At this time, the control unit acquires the rotational angle of the arm detected by the encoder in a state in which the tension bar is in contact with the stopper.

In step S14, the control unit sets the reference angle. Specifically, the control unit sets, as the reference angle, the rotational angle of the arm acquired in step S13. Upon ending the process of step S14, the control units ends the setting operation. In this manner, the method of controlling the printing apparatus 11 includes causing the tension bar or the arm to come into contact with the stopper, and also includes setting, as the reference angle, the rotational angle of the arm detected by the encoder in this state.

### Operations and Effects

Next, operations and effects of the embodiment described above will be described.
(1) The feeding control unit 48 sets, as a reference angle of the first arm 37, a rotational angle of the first arm 37 detected by the first encoder 45 in a state in which the first tension bar 36 or the first arm 37 is in contact with the first upper-side stopper 46.

It is necessary to set the reference angle of the first arm 37 in order for the first encoder 45 to detect the rotational angle of the first arm 37. With the configuration described above, it is possible to easily set the reference angle of the first arm 37 without using any photosensor.
(2) The first upper-side stopper 46 comes into contact with the first tension bar 36 or the first arm 37 from above.

The medium 99 is looped over the first tension bar 36 from below, and hence, the first tension bar 36 receives, from the medium 99, force that causes upward movement. That is, the first tension bar 36 is more likely to be displaced upward. Thus, with the configuration described above, it is easy to make the first tension bar 36 or the first arm 37 come into contact with the first upper-side stopper 46. In a case where the stopper comes into contact with the first tension bar 36 or the first arm 37 from below, it is difficult to cause the first tension bar 36 or the first arm 37 to come into contact with the stopper.
(3) The first tension applying unit 35 includes the first lower-side stopper 47 configured to come into contact with the first tension bar 36 or the first arm 37 from below. With the configuration described above, it is possible to set the reference angle of the first arm 37 not only by causing the first tension bar 36 or the first arm 37 to come into contact with the first upper-side stopper 46 but also by causing the first tension bar 36 or the first arm 37 to come into contact with the first lower-side stopper 47.
(4) The feeding control unit 48 controls the first motor 39 to cause the first tension bar 36 or the first arm 37 to come into contact with the first upper-side stopper 46.

With the configuration described above, it is possible to easily cause the first tension bar 36 or the first arm 37 to come into contact with the first upper-side stopper 46.
(5) The winding control unit 68 sets, as the reference angle of the second arm 57, the rotational angle of the second arm 57 detected by the second encoder 65 in a state in which the second tension bar 56 or the second arm 57 is in contact with the second upper-side stopper 66. With the configuration described above, it is possible to easily set the reference angle of the second arm 57 without using any photosensor not only at the time of feeding out the medium 99 but also at the time of winding the medium 99.

### Modification Examples

The embodiment described above can be implemented by making modification in the following manner. The embodiment described above and the following modification examples can be implemented by combining them as long as no technical contradiction arises due to the combination.
It may be possible to employ a configuration in which the control unit controls the transport unit 27 and the feeding shaft 32 to cause the first tension bar 36 or the first arm 37 to come into contact with the stopper. The control unit may set the reference angle in this state. For example, by using the transport unit 27 and the feeding shaft 32 to pull the medium 99 or loosen the medium 99, it is possible to cause the first tension bar 36 or the first arm 37 to come into contact with the stopper.
It may be possible to employ a configuration in which the control unit controls the transport unit 27 and the winding shaft 52 to cause the second tension bar 56 or the second arm 57 to come into contact with the stopper. The control unit may set the reference angle in this state. For example, by using the transport unit 27 and the winding shaft 52 to pull the medium 99 or loosen the medium 99, it is possible to cause the second tension bar 56 or the second arm 57 to come into contact with the stopper.
The liquid that the printing section 23 discharges is not limited to ink, and may be, for example, a liquid body in which particles of a functional material are dispersed in or mixed with a liquid. For example, the printing section 23 may discharge a liquid body including, in a dispersed or dissolved form, a material such as an electrode material or a pixel material used in manufacturing a liquid crystal display, an electroluminescence display, a surface emitting display, or the like.

### Technical Ideas

Below, description will be made of technical ideas, operation and effects thereof derived from the embodiment and the modification described above.
(A) A printing apparatus includes: a feeding shaft configured to support a roll body around which a medium is wound; a printing section configured to perform printing on the medium fed from the feeding shaft; a tension applying unit configured to come into contact with the medium after the medium is fed out by the feeding shaft and before the medium reaches the printing section, thereby applying tension to the medium; and a control unit, in which the tension applying unit includes: a tension bar configured to come into contact with the medium; an arm configured to support the tension bar and rotate to displace the tension bar; an encoder configured to detect a rotational angle of the arm; and a stopper configured to come into contact with the tension bar or the arm to restrict movement of the tension bar and the arm, and the control unit sets, as a reference angle of the arm, a rotational angle of the arm detected by the encoder in a state in which the tension bar or the arm is in contact with the stopper.

It is necessary to set the reference angle of the arm in order for the encoder to detect the rotational angle of the arm. With the configuration described above, it is possible to easily set the reference angle of the arm without using any photosensor.
(B) The printing apparatus described above may be configured such that the tension bar is disposed such that the medium is looped over from below, and the stopper comes in contact with the tension bar or the arm from above.

Since the medium is looped over the tension bar from below, the tension bar receives, from the medium, force that causes upward movement. That is, the tension bar is more likely to be displaced upward. Thus, with the configuration described above, it is easy to cause the tension bar or the arm to come into contact with the stopper. In a case where the stopper comes into contact with the tension bar or the arm from below, it is difficult to cause the tension bar or the arm to come into contact with the stopper.
(C) The printing apparatus described above may be configured such that the stopper is an upper-side stopper, and the tension applying unit includes a lower-side stopper configured to come into contact with the tension bar or the arm from below.

With the configuration described above, it is possible to set the reference angle of the arm not only by causing the tension bar or the arm to come into contact with the upper-side stopper but also by causing the tension bar or the arm to come into contact with the lower-side stopper.
(D) The printing apparatus described above may be configured such that the printing apparatus includes a motor configured to rotate the arm, the arm rotates to move the tension bar upward and downward, and the control unit controls the motor to cause the tension bar or the arm to come into contact with the stopper. With the configuration described above, it is possible to easily cause the tension bar or the arm to come into contact with the stopper.
(E) The printing apparatus may be configured such that the tension applying unit is a first tension applying unit, the tension bar is a first tension bar, the arm is a first arm, the encoder is a first encoder, the stopper is a first stopper, the printing apparatus includes: a winding shaft configured to support a roll body around which the medium on which printing is performed is wound; and a second tension applying unit configured to come into contact with the medium after the printing section performs printing on the medium and before the medium is wound by the winding shaft, thereby applying tension to the medium, the second tension applying unit includes: a second tension bar configured to come into contact with the medium; a second arm configured to support the second tension bar and rotate to displace the second tension bar; a second encoder configured to detect a rotational angle of the second arm; and a second stopper configured to come into contact with the second tension bar or the second arm to restrict movement of the second tension bar and the second arm, and the control unit sets, as a reference angle of the second arm, a rotational angle of the second arm detected by the second encoder in a state in which the second tension bar or the second arm is in contact with the second stopper. With the configuration described above, it is possible to easily set the reference angle of the second arm without using any photosensor not only at the time of feeding out the medium but also at the time of winding the medium.
(F) A method of controlling a printing apparatus, the printing apparatus including: a feeding shaft configured to support a roll body around which a medium is wound; a printing section configured to perform printing on the medium fed by the feeding shaft; and a tension applying unit configured to come into contact with the medium after the medium is fed out from the feeding shaft and before the medium reaches the printing section, thereby applying tension to the medium, in which the tension applying unit includes: a tension bar configured to come into contact with the medium; an arm configured to support the tension bar and rotate to displace the tension bar; an encoder configured to detect a rotational angle of the arm; and a stopper configured to come into contact with the tension bar or the arm to restrict movement of the tension bar and the arm, the method including: causing the tension bar or the arm to come into contact with the stopper; and setting, as a reference angle of the arm, a rotational angle of the arm detected by the encoder in a state in which the tension bar or the arm is in contact with the stopper. With the method described above, it is possible to obtain effects similar to those of the printing apparatus described above.

What is claimed is:

1. A printing apparatus comprising:
a feeding shaft configured to support a roll body around which a medium is wound;
a printing section configured to perform printing on the medium fed from the feeding shaft;
a tension applying unit configured to come into contact with the medium after the medium is fed out by the feeding shaft and before the medium reaches the printing section, thereby applying tension to the medium; and
a control unit, wherein
the tension applying unit includes:
a tension bar configured to come into contact with the medium;
an arm configured to support the tension bar and rotate to displace the tension bar;
an encoder configured to detect a rotational angle of the arm; and
a stopper configured to come into contact with the tension bar or the arm to restrict movement of the tension bar and the arm, and
the control unit sets, as a reference angle of the arm, a rotational angle of the arm detected by the encoder in a state in which the tension bar or the arm is in contact with the stopper.

2. The printing apparatus according to claim 1, wherein
the tension bar is disposed such that the medium is looped over from below, and
the stopper comes in contact with the tension bar or the arm from above.

3. The printing apparatus according to claim 2, wherein
the stopper is an upper-side stopper, and
the tension applying unit includes a lower-side stopper configured to come into contact with the tension bar or the arm from below.

4. The printing apparatus according to claim 1 further comprising:
a motor configured to rotate the arm, wherein
the arm rotates to move the tension bar upward and downward, and
the control unit controls the motor to cause the tension bar or the arm to come into contact with the stopper.

5. The printing apparatus according to claim 1, wherein
the tension applying unit is a first tension applying unit,
the tension bar is a first tension bar,
the arm is a first arm,
the encoder is a first encoder,
the stopper is a first stopper,
the printing apparatus includes:
a winding shaft configured to support a roll body around which the medium on which printing is performed is wound; and
a second tension applying unit configured to come into contact with the medium after the printing section performs printing on the medium and before the medium is wound by the winding shaft, thereby applying tension to the medium,
the second tension applying unit includes:
a second tension bar configured to come into contact with the medium;
a second arm configured to support the second tension bar and rotate to displace the second tension bar;
a second encoder configured to detect a rotational angle of the second arm; and
a second stopper configured to come into contact with the second tension bar or the second arm to restrict movement of the second tension bar and the second arm, and
the control unit sets, as a reference angle of the second arm, a rotational angle of the second arm detected by the second encoder in a state in which the second tension bar or the second arm is in contact with the second stopper.

6. A method of controlling a printing apparatus,
the printing apparatus including:
a feeding shaft configured to support a roll body around which a medium is wound;
a printing section configured to perform printing on the medium fed from the feeding shaft; and
a tension applying unit configured to come into contact with the medium after the medium is fed out by the feeding shaft and before the medium reaches the printing section, thereby applying tension to the medium, wherein
the tension applying unit includes:
a tension bar configured to come into contact with the medium;
an arm configured to support the tension bar and rotate to displace the tension bar;
an encoder configured to detect a rotational angle of the arm; and
a stopper configured to come into contact with the tension bar or the arm to restrict movement of the tension bar and the arm,
the method including:
causing the tension bar or the arm to come into contact with the stopper; and
setting, as a reference angle of the arm, a rotational angle of the arm detected by the encoder in a state in which the tension bar or the arm is in contact with the stopper.
